(19) United States
(12) Patent Application Publication
(10) Pub. No.: US 2010/0026203 A1
(43) Pub. Date: Feb. 4, 2010

(54) LED DRIVER WITH FRAME-BASED DYNAMIC POWER MANAGEMENT

(75) Inventors: Bin Zhao, Irvine, CA (US); Jack W. Cornish, Foothill Ranch, CA (US); Brian B. Horng, Irvine, CA (US); Andrew M. Kameya, Irvine, CA (US); Jan Krellner, Chandler, AZ (US); Kenneth C. Kwok, Irvine, CA (US); Victor K. Lee, Irvine, CA (US); Weizhuang W. Xin, Aliso Viejo, CA (US)

Correspondence Address: LARSON NEWMAN & ABEL, LLP, 5914 WEST COURTYARD DRIVE, SUITE 200, AUSTIN, TX, 78730, US

(73) Assignee: Freescale Semiconductor, Inc., Austin, TX (US)

(21) Appl. No.: 12/183,492

(22) Filed: Jul. 31, 2008

(51) Int. Cl. H05B 33/00

(52) U.S. Cl. 315/291

(57) ABSTRACT

Disclosed are example techniques for frame-based power management in a light emitting diode (LED) system having a plurality of LED strings. A voltage source provides an output voltage to drive the LED strings. An LED driver generates a frame timing reference representative of the frame rate or display timing of a series of image frames to be displayed via the LED system. An update reference is generated from the frame timing reference. The LED driver monitors one or more operating parameters of the LED system. In response to update triggers marked by the update reference, the LED driver adjusts the output voltage of the voltage source based on the status of each of the one or more monitored operating parameters (either from the previous update period or determined in response to the update trigger), thereby synchronizing the updating of the output voltage to the frame rate (or a virtual approximation of the frame rate) of the video being displayed.

### FIELD OF THE DISCLOSURE

The present disclosure relates generally to light emitting diode (LED) displays and more particularly to LED drivers for LED displays.

### BACKGROUND

Light emitting diodes (LEDs) often are used for backlighting sources in liquid crystal displays (LCDs), direct LED displays, and other displays. In LED display implementations, the LEDs are arranged in parallel “strings” driven by a shared output voltage, each LED string having a plurality of LEDs connected in series. During operation, conventional LED drivers typically continuously adjust the output voltage to compensate for changes in certain monitored characteristics of the LED system. This continual adjustment often is conducted in a manner such that any given change in the output voltage does not have a chance to settle in the LED system before the output voltage is changed yet again, thereby leading to instability in the LED system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a light emitting diode (LED) system having frame-based dynamic power management in accordance with at least one embodiment of the present disclosure.

FIG. 2 is a diagram illustrating various examples for generating an update reference from a frame timing reference in the LED system of FIG. 1 in accordance with at least one embodiment of the present disclosure.

FIG. 3 is a flow diagram illustrating an example method of operation of the LED system of FIG. 1 in accordance with at least one embodiment of the present disclosure.

FIG. 4 is a flow diagram illustrating a particular process of FIG. 3 in greater detail in accordance with at least one embodiment of the present disclosure.

FIG. 5 is a chart illustrating an example of a frame-based power management process in accordance with at least one embodiment of the present disclosure.

FIG. 6 is a diagram illustrating a particular implementation of the LED system of FIG. 1 in accordance with at least one embodiment of the present disclosure.

FIG. 7 is a flow diagram illustrating a method of operation of the LED system of FIG. 6 in accordance with at least one embodiment of the present disclosure.

FIG. 8 is a flow diagram illustrating the method of FIG. 7 in greater detail in accordance with at least one embodiment of the present disclosure.

FIG. 9 is a diagram illustrating an example implementation of a feedback controller of the LED system of FIG. 6 in accordance with at least one embodiment of the present disclosure.

FIG. 10 is a flow diagram illustrating a method of operation of the example implementation of FIG. 9 in accordance with at least one embodiment of the present disclosure.

FIG. 11 is a diagram illustrating an integrated circuit (IC)-based implementation of the LED systems of FIGS. 1 and 6 in accordance with at least one embodiment of the present disclosure.

### DETAILED DESCRIPTION

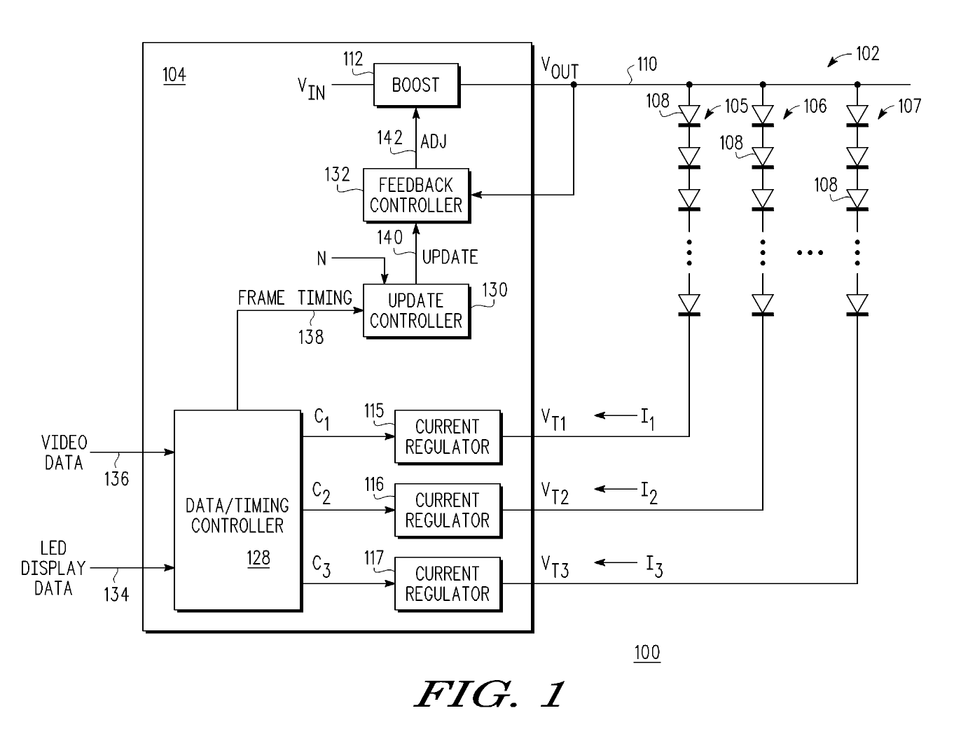

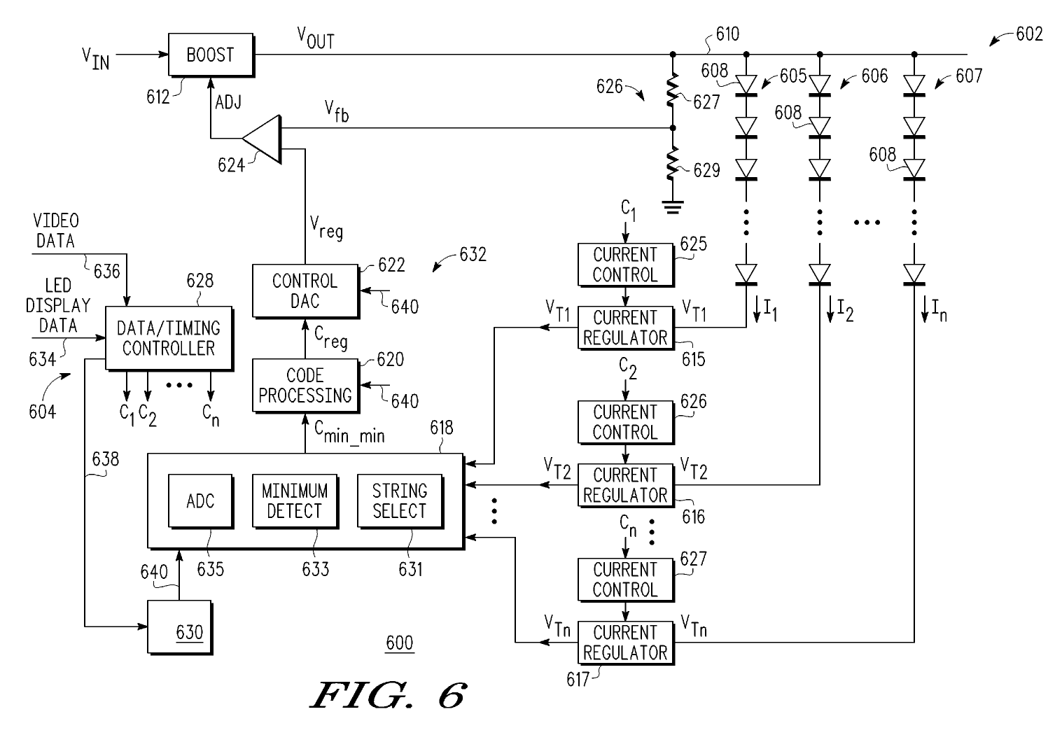

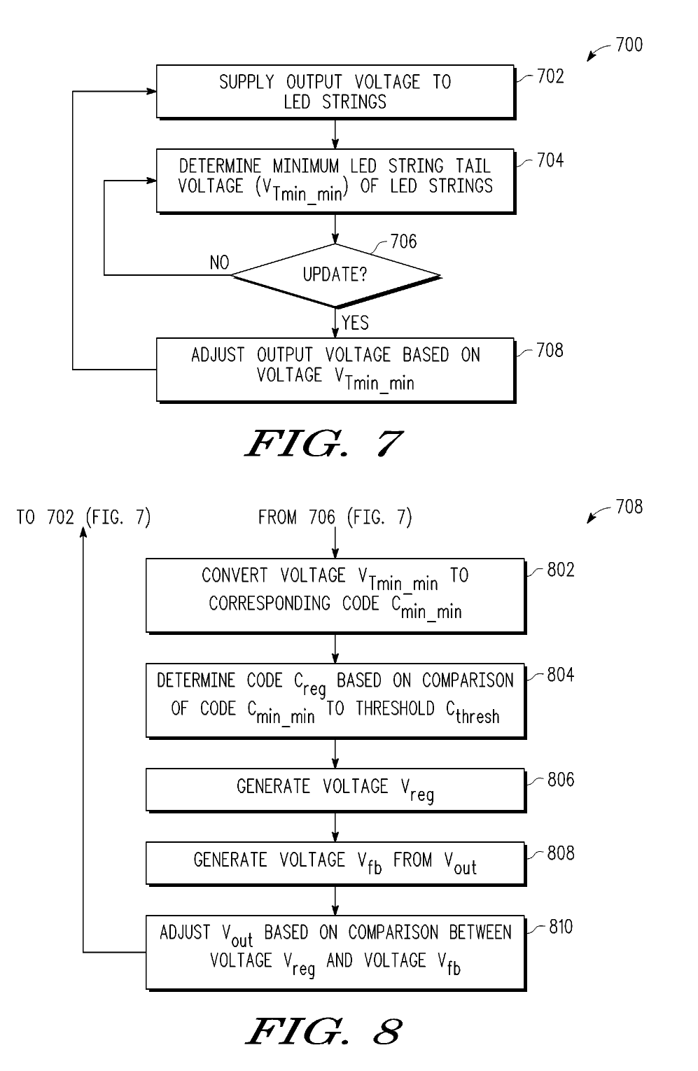

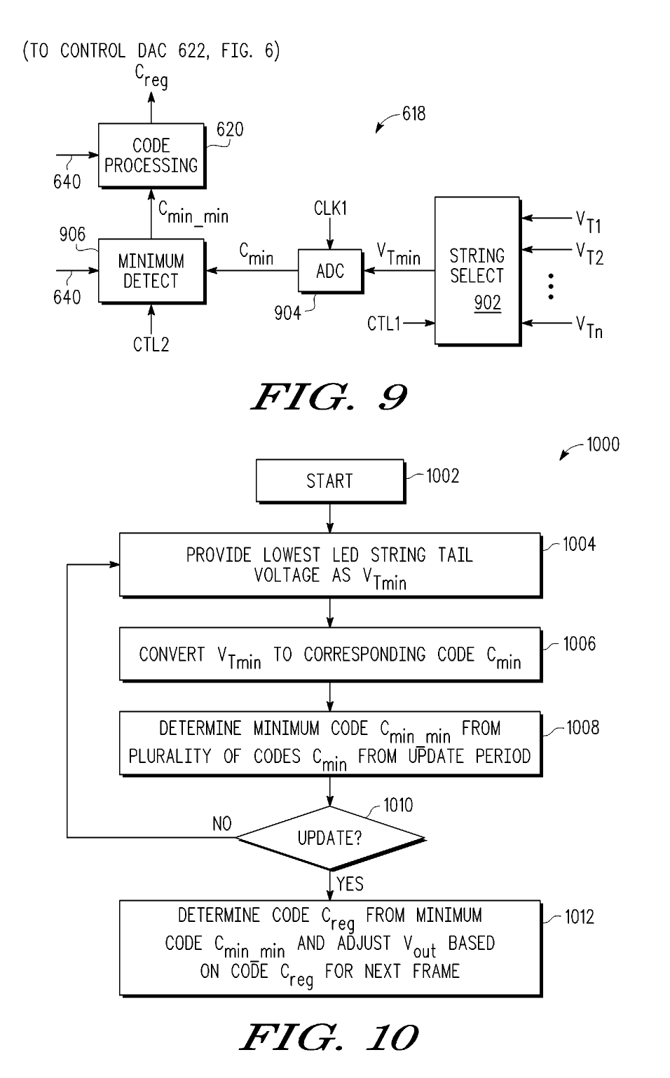

FIGS. 1-11 illustrate example techniques for frame-based power management in a light emitting diode (LED) system having a plurality of LED strings. A voltage source provides an output voltage to drive the LED strings. An LED driver generates a frame timing reference representative of the frame rate and display timing of a series of image frames to be displayed via the LED system. An update reference is generated from the frame timing reference as a harmonic or subharmonic of the frame rate of the frame timing reference, or with some selected sub-set of the frame-related signals of the frame timing reference. The LED driver monitors one or more operating parameters of the LED system. In response to update triggers marked by the update reference, the LED driver adjusts the output voltage of the voltage source based on the status of each of the one or more monitored operating parameters (either from the previous update period or determined in response to the update trigger), thereby synchronizing the updating of the output voltage to the frame rate of the video being displayed. FIGS. 6-11 illustrate particular embodiments whereby an operating parameter being monitored for periodic updates to the output voltage includes the minimum, or lowest, tail voltage of the plurality of LED strings.

The term “LED string,” as used herein, refers to a grouping of one or more LEDs connected in series. The “head end” of a LED string is the end or portion of the LED string which receives the driving voltage/current and the “tail end” of the LED string is the opposite end or portion of the LED string. The term “tail voltage,” as used herein, refers the voltage at the tail end of a LED string or representation thereof (e.g., a voltage-divided representation, an amplified representation, etc.).

FIG. 1 illustrates a LED system 100 having frame-based dynamic power management in accordance with at least one embodiment of the present disclosure. In the depicted example, the LED system 100 includes a LED panel 102, a LED driver 104, and a voltage source 112 for providing an output voltage V_{OUT} to drive the LED panel 102. The LED panel 102 includes a plurality of LED strings (e.g., LED strings 105, 106, and 107). Each LED string includes one or more LEDs 108 connected in series and each LED string is driven by the adjustable voltage V_{OUT} received at the head end of the LED string via a voltage bus 110 (e.g., a conductive trace, wire, etc.). The LEDs 108 can include, for example, white LEDs, red, green, blue (RGB) LEDs, organic LEDs (OLEDs), etc. In the embodiment of FIG. 1, the voltage source 112 is implemented as a boost converter configured to drive the output voltage V_{OUT} using an input voltage V_{IN}. The voltage source 112 also can be implemented as a step-down buck converter, a buck-boost converter, charge pump converter, and the like. Further, as illustrated, the voltage source 112 can be implemented, in whole or in part, at the LED driver 104, or the voltage source 112 can be implemented separate from the LED driver.

The LED driver 104, in at least one embodiment, is configured to control the voltage source 112 so as to provide the output voltage V_{OUT} at a magnitude sufficient to meet predetermined criteria for one or more operating parameters of the LED system 100, such as maintaining a minimum tail voltage of the tail voltages V_{T1}, V_{T2}, and V_{T3} of LED strings 105-107, respectively, at, near, or below a predetermined threshold, maintaining the output voltage V_{OUT} at or near a predetermined voltage level, etc. Further, in at least one embodiment, the LED driver 104 is configured to maintain the current flowing through the each of the LED strings 105-107 at or near a predetermined current level when the LED string is activated.

In the depicted example, the LED driver 104 includes a plurality of current regulators (e.g., current regulators 115, 116, and 117), a data/timing controller 128, an update controller 130, and a feedback controller 132. In the example of FIG. 1, the current regulator 115 is configured to maintain the current I₁ flowing through the LED string 105 at or near a targeted current (e.g., 30 mA) when active. Likewise, the current regulator 116 is configured to maintain the current I₂ flowing through the LED string 106 when active at or near a targeted current and the current regulator 117 is configured to maintain the current I₃ flowing through the LED string 107 when active at or near a targeted current.

The data/timing control module 128 is configured to receive LED display data 134 and video data 136 associated with video information to be displayed at a display device (not shown) implementing the LED panel 102, whereby the video information comprises a series of image frames to be displayed at an indicated frame rate. The LED display data 134 can include, for example, LED current level data that controls the current level in each of the LED strings 105-107 as a function of time. Alternately, the LED display data 134 can include pulse width modulation (PWM) data that indicates which of the LED strings 105-107 are to be activated and at what times during a corresponding PWM cycle, in response to which the LED driver 104 is configured to individually activate the LED strings 105-107 at the appropriate times in their respective PWM cycles. Accordingly, the data/timing controller 128 is configured to provide control signals to the other components of the LED driver 104 based on the timing and activation information represented by the LED display data 134. To illustrate, the data/timing control module 128 provides control signals C₁, C₂, and C₃ to control which of the LED strings 105-107 are active during corresponding portions of their respective PWM cycles. Although FIG. 1 illustrates an example embodiment whereby the LED display data 134 is received separate from the video data 136, in an alternate embodiment, the data/timing control module 128 can determine the LED display data 134 from the video data 136.

The video data 136 includes frame information indicating timing of the display of the image frames (e.g., indicating the start of the display of each image frame). Examples of the frame information can include, for example, the vertical synchronization (VSYNC) signaling provided in National Television Standards Committee (NTSC)-based systems, Phase Alternating Line (PAL)-based systems, and High Definition Television (HDTV)-based systems, the Vertical Blanking Interface (VBI) utilized in a Visual Graphics Array (VGA) or Digital Video Interface (DVI)-based system. Other signaling associated with frame changes can be used without departing from the scope of the present disclosure. In at least one embodiment, the data/timing controller 128 utilizes the frame rate information implemented in the video data 136 to provide a frame timing reference 138, whereby the frame timing reference 138 comprises digital or analog signaling identifying the timing of the start of the display of each image frame at the display device having the LED panel 102.

The update controller 130 is configured to utilize the frame timing reference 138 to control the timing of the updating or adjustment of output voltage V_{OUT} provided by the voltage source 112. In at least one embodiment, the update controller 130 generates an update reference 140 based on the frame timing reference 138, whereby the update reference 140 can be a harmonic of the frame rate (FR) represented by the frame timing reference 138 (e.g., FR*N, whereby N is an integer), the update reference 140 can be a subharmonic of the frame rate (e.g., FR/N), or the update reference 140 be equal to the frame timing reference 138 (e.g., whereby the update controller 130 passes the frame timing reference 138 through as the update reference 140 without modification or whereby the feedback controller 132 utilizes the frame timing reference 138 directly rather than utilizing the update reference 140 generated based on the frame timing reference 138). The harmonic variable N utilized to generate the update reference 140 as a harmonic or subharmonic of the frame timing reference 138 can be obtained in any of a variety of ways. To illustrate, the harmonic variable N can be stored and accessed from a register or non-volatile memory (e.g., a flash memory), the harmonic variable N can be generated from a digitization of a voltage generated via a resistor (e.g., an external resistor having an adjustable resistance so as to permit programming of the harmonic variable N), and the like. In another embodiment, the update controller 130 generates the update reference 140 from a non-harmonic subset of the frame rate represented by the frame timing reference 138 by utilizing a predefined selection algorithm or selection pattern determined by, for example, a condition at the feedback controller 132 or the previous update history. For example, the update controller 130 can use a selection pattern, represented as FR*N/C, so as to select every Cth update trigger generated by the harmonic FR*N. To illustrate, the update controller 130 can generate a reference signal having a frequency of FR*2 (i.e., N=2) and then count every third (i.e., C=3) cycle of the reference signal to generate the corresponding update reference 140.

In yet another embodiment, the update controller 130, rather than using the frame timing reference 138, can instead generate the update reference 140 via generation of a virtual frame timing reference that represents a virtual frame rate that serves as an approximation of the expected frame rate of the video data. To illustrate, in one embodiment, the update controller 130 can generate the update reference 140 through information in the video data 136 in real time. In another embodiment, the update controller 130 can implement a virtual frame timing reference source, such as an oscillator, a phase locked loop (PLL) or other clocking source, to generate a clock signal that has a fixed frequency approximately equal to or otherwise based on the fastest expected frame rate for the video data 136, and this clock signal can be provided as the update reference 140. In one embodiment, the fixed frequency can be dynamically changed to accommodate for frame rate changes by, for example, a source of the video data 136 (e.g., a digital signal processor (DSP)) by, for example, writing a value associated with a particular frame rate to a register associated with the clock source.

The feedback controller 132 is configured to receive the update reference 140 and to provide an adjustment signal ADJ (also identified as signal 142 in FIG. 1) responsive to the update reference 140, whereby the adjustment signal ADJ is configured to control the voltage source 112 to adjust the output voltage V_{OUT}. As described in greater detail herein, the feedback controller 132 is configured to initiate an update process in response to update triggers in the update reference 140, whereby the update process comprises determining an actual state for each of one or more operating parameters of the LED system 100, determining the relationship between the actual state and a target state for a given operating parameter, and configuring the adjustment signal ADJ to adjust the output voltage V_{OUT} accordingly. In one embodiment, the feedback controller 132 receives the tail voltages V_{T1}, V_{T2}, and V_{T3} of LED strings 105-107, and the considered operating parameter includes a minimum tail voltage of the LED strings 105-107, which is compared to a tail voltage threshold to determine whether to increase or decrease the output voltage V_{OUT}. In another embodiment, a considered operating parameter is the magnitude of the output voltage V_{OUT} itself, which is compared with a target magnitude for the output voltage V_{OUT} to determine whether to increase or decrease the level of the output voltage V_{OUT}.

In one embodiment, the feedback controller 132 initiates the update process in response to each update trigger in the update reference 140. In an alternate embodiment, the feedback controller 132 uses additional criteria to determine whether to initiate the update process in response to an update trigger. A previous adjustment to the output voltage V_{OUT} may take considerable time to settle throughout the LED system 100, particularly in the case of an increase in the output voltage V_{OUT} and thus the operating parameters affected by the magnitude of the output voltage V_{OUT} typically will not be reliable indicators of whether further adjustment is necessary until the output voltage V_{OUT} is settled. Accordingly, in at least one embodiment, the feedback controller 132 maintains an update history of the last update made to the output voltage V_{OUT} and monitors the output voltage V_{OUT} to determine whether the output voltage V_{OUT} has settled to the target voltage. If the output voltage has not sufficiently settled, the feedback controller 132 may disregard an update trigger in the update reference 140 so as to avoid further adjustment to the output voltage V_{OUT}. The feedback controller 132 can determine whether the output voltage V_{OUT} is sufficiently settled based on the manner in which the feedback controller 132 uses the operating parameters to update the output voltage V_{OUT}.

To illustrate, if the feedback controller 132 uses, for example, the instantaneous minimum tail voltage of the tail voltages of the LED strings 105-107 at the time of the update trigger, then the output voltage V_{OUT} typically would be considered to be sufficiently settled if it settles to the target magnitude before the update trigger occurs. In contrast, if the feedback controller 132 uses, for example, the minimum tail voltage of the tail voltages of the LED strings 105-107 of the duration of a frame as the operating parameter and the last update to the output voltage V_{OUT} resulted in an increase in magnitude of the output voltage V_{OUT}, it may not be sufficient for the output voltage to settle for only part of a frame duration to use the minimum tail voltage over that frame duration. That is, the detected minimum tail voltage detected during this only partially-settled frame duration may not be accurate indicators of the state of the LED strings 105-107 with the targeted magnitude for the output voltage V_{OUT} implemented. Thus, in this situation the feedback controller 132 would wait until the next update trigger before initiating the update process so to determine the minimum tail voltage over the next frame duration whereby the output voltage V_{OUT} is settled for the full duration.

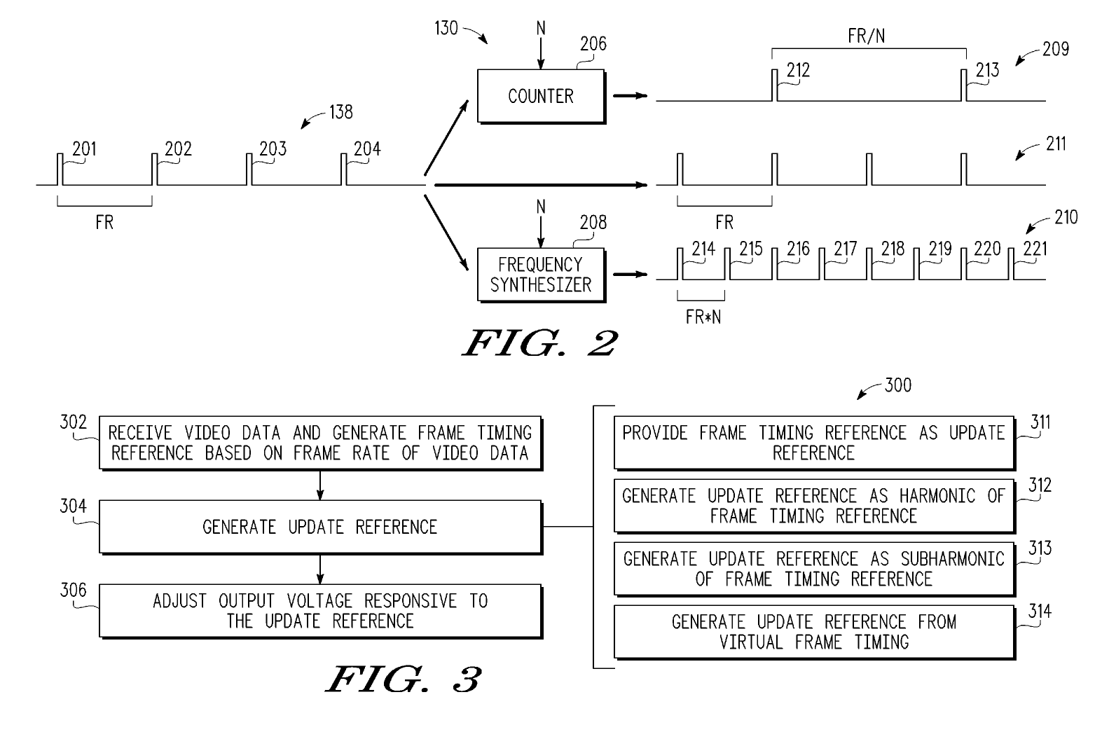

FIG. 2 illustrates an example implementation of the update controller 130 in accordance with at least one embodiment of the present disclosure. As discussed above, the update controller 130 generates an update reference 140 as either a harmonic or subharmonic of the frame timing reference 138 or the update controller 130 provides the frame timing reference 138 directly as the update reference 140. Alternately, the update controller 130 can generate the update reference 140 based on an aperiodic subset of the frame changes indicated in the frame timing reference 138. In the depicted example, the frame timing reference 138 is represented as a series of pulses (e.g., pulses 201-204), each pulse corresponding to the start of the display of a corresponding image frame.

To generate the update reference 140 as a subharmonic of the frame timing reference 138, the update controller 130 can include, for example, a counter 206 that has an input to receive the harmonic variable N, an input to receive the frame timing reference 138, and an output to provide an update reference 209 (one example of the output reference 140) having a frequency of FR/N by, for example, asserting (e.g., pulsing) the update reference 209 for every N pulses detected in the frame reference 138. In the example of FIG. 2, the harmonic variable N is set to two (2), and thus the counter 206 generates the update reference 209 as having two pulses (e.g., pulses 212 and 213) for the illustrated four pulses 201-204 of the frame timing reference 138. To generate the update reference 140 as a harmonic of the frame timing reference 138, the update controller 130 can include, for example, a frequency synthesizer 208 that has an input to receive the harmonic variable N, an input to receive the frame timing reference 138, and an output to provide an update reference 210 (another example of the update reference 140) having a frequency of N*FR. As illustrated, with the harmonic variable N set to two (2), the frequency synthesizer 208 generates the update reference 210 as having eight pulses (e.g., pulses 214-221) for the illustrated four pulses 201-204 of the frame timing reference 138. Further, to provide the update reference 140 as representing the frame rate of the video without modification, the update controller 130 can be bypassed or omitted and the frame timing reference 138 can be provided without modification as an update reference 211 (another example of the update reference 140) to the feedback controller 132. As also described above, instead of using the frame timing information in the video data 136, the update controller 130 instead can generate the update reference 140 based on a virtual frame timing reference, such as a generated clock signal having a frequency approximately equal to an expected frame rate of the video data 136.

As illustrated by FIG. 2, the update reference 140 defines update triggers marked by assertions (e.g., pulses or other voltage level changes) in the update reference 140. As described below, these update triggers are utilized to control the initiation of an update process for adjusting the output voltage V_{OUT}. As the pulses 201-204 of the frame timing reference 138 represent the start (or the end) of each frame in a series of frames associated with the video data (e.g., frames 1, 2, 3, and 4), the update triggers can be initiated at the start of selected frames of a set of contiguous image frames of the series, as illustrated by the update reference 211. Alternately, as illustrated by the update reference 209, the update triggers can be initiated at the start of each of a set of discontiguous image frames of the series (e.g., at the start of every alternate frame (frames 2 and 4), every third image frame, etc.). Alternately, the update triggers can be implemented at a harmonic of the frame rate (FR*N) as illustrated by the update reference 210, or the update triggers can be implemented in accordance with a predetermined selection scheme that takes into account both the frame timing and a status of the feedback controller 132 (e.g., whether it updated the output voltage V_{OUT} in the previous update period).

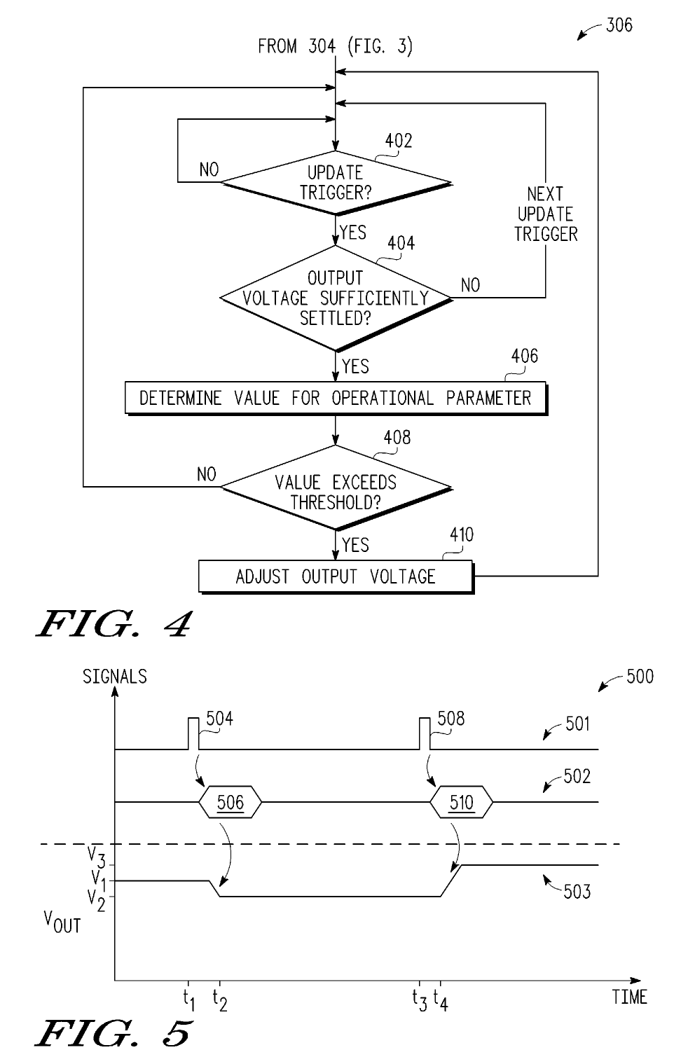

FIG. 3 illustrates an example method 300 of operation of the LED system 100 of FIG. 1 in accordance with at least one embodiment of the present disclosure. Although FIG. 3 illustrates a series of discrete blocks 302, 304, and 306 for ease of discussion, the method 300 is a continuous process whereby the processes represented by each of the blocks are performed substantially concurrently.

At block 302, the data/timing controller 128 of the LED driver 104 receives the video data 136 and generates the frame timing reference 138 from the video data 136 based on the frame rate of the series of image frames associated with the video data 136. As discussed above, the frame timing reference 138 can include, for example, signaling representative of the VSYNC timing in the video data 136, where each occurrence of a VSYNC signal in the video data 136 is represented by a corresponding pulse or other voltage level change in the frame timing reference 138.

At block 304, the update controller 130 generates the update reference 140 from the frame timing reference 138 as the frame timing reference 138 is being generated by the data/timing controller 128. As illustrated, the generation of the update reference 140 can include a pass-through process 311 whereby the frame timing reference 138 is directly provided as the update reference 140 so that the update reference 140 has a frequency and timing equal to the frame rate of the video data 136. Alternately, the generation of the update reference 140 can include a subharmonic process 312 whereby the update controller 130 uses a counter 206 (FIG. 2) or other mechanism to generate the update triggers in the update reference 140 with a frequency that is 1/N of the frame rate FR of the video data 136 (i.e., equal to FR/N, N being an integer). As another example, the generation of the update reference 140 can include a harmonic process 313 whereby the update controller 130 uses a frequency synthesizer 208 (FIG. 2) or other mechanism to generate the update triggers in the update reference 140 with a frequency that is an integer N times the frame rate FR of the video data 136 (i.e., equal to FR*N). As another alternate process, rather than using the actual frame timing reference 138, the generation of the update reference 140 can include a virtual timing process 314 whereby the update controller 130 uses a clock source to generate a virtual timing reference representative of the expected frame rate of the video data 136 and then generates the update reference 140 from this virtual frame timing reference (e.g., as a harmonic or subharmonic of the virtual frame rate represented by the virtual timing reference, or the virtual timing reference is provided directly as the update reference 140).

At block 306, the feedback controller 132 adjusts the output voltage V_{OUT} responsive to the update reference 140 as the update reference 140 is generated by the update controller 130. The feedback controller 132 can adjust the output voltage V_{OUT} by controlling the voltage source 112 via the adjust signal ADJ. As described herein, the feedback controller 132 uses the update triggers (e.g., pulses or other assertion features) present in the update reference 140 to initiate adjustment of the output voltage V_{OUT} based on an assessment of one or more operating parameters of the LED system 100 related to the output voltage V_{OUT}. As also discussed herein, the initiation of the update process also may be controlled by the update history and the current settling status of the output voltage V_{OUT}.

FIG. 4 illustrates an example implementation of the process of block 306 of method 300 of FIG. 3 in accordance with at least one embodiment of the present disclosure. At block 402, the feedback controller 132 analyzes the update reference 140 as it is being received from the update controller 130. In the event that the feedback controller 132 detects that the update reference 140 has been asserted (e.g., a pulse or other voltage level change is detected in the update reference 140), at block 404 the feedback controller 132 determines its update history of the last adjustment to the output voltage V_{OUT} and further determines whether the output voltage V_{OUT} has sufficiently settled after the adjustment. To illustrate, if the adjustment involved an increase in the magnitude of the output voltage V_{OUT} and the monitored operational parameter of the LED system 100 comprises the minimum tail voltage of the LED strings 105-107 (FIG. 1) over an entire frame, then the output voltage V_{OUT} may only be deemed to be sufficiently settled once it has settled at or sufficiently near the target magnitude for an entire frame. Alternately, if the adjustment involves a decrease in the magnitude of the output voltage V_{OUT}, or if the monitored operational parameter is the instantaneous minimum tail voltage of the LED strings 105-107 at the time of the update trigger, the feedback controller 132 may deem the output voltage V_{OUT} to be sufficiently settled in the event that it is at or sufficiently near the target magnitude at the time that the instantaneous minimum tail voltage is determined.

If the output voltage V_{OUT} is not sufficiently settled, the feedback controller 132 disregards the update trigger and the process returns to block 402 whereby the feedback controller 132 waits for the next update trigger before initiating the update process so as to allow the output voltage V_{OUT} to become sufficiently settled. Otherwise, if the feedback controller 132 deems the output voltage V_{OUT} to be sufficiently settled by the time of the update trigger, at block 406 the feedback controller 132 analyzes the operational parameter of the LED system 100 to determine a value representative of the current status of the operational parameter. As described in greater detail herein, the operational parameter can include, for example, the instantaneous minimum tail voltage of the tail voltages (V_{T1}, V_{T2}, V_{T3}) of the LED strings 105-107 (FIG. 1) at the time that the update trigger of the update reference 402 is detected or the minimum tail voltage of the tail voltages of the LED strings 105-107 for the period between the immediately previous update trigger of the update reference 140 and the currently detected update trigger of the update reference 140. As another example, the operating parameter can include the magnitude of the output voltage V_{OUT}, either at the time of the currently detected update trigger of the update reference 140 or as a minimum or maximum magnitude for the period between the previous and current update triggers of the update reference 140.

At block 408, the feedback controller 132 determines whether the determined status of the operating parameter exceeds a predetermined threshold associated with the operating parameter. To illustrate, if the operating parameter pertains to the minimum tail voltage of the LED strings 105-107, the predetermined threshold could be a target voltage level (e.g., 0.5 V) or target voltage level range (e.g., 0.4V to 0.6 V) for the minimum tail voltage of the LED strings 105-107, which could be exceeded if the minimum tail voltage falls below or falls above the target voltage level or target voltage level range. As another example, if the operating parameter pertains to the magnitude of the output voltage V_{OUT}, the predetermined threshold could be a target voltage level (e.g., 50 V) or a target voltage level range (e.g. 48 V to 52 V) for the output voltage V_{OUT}.

In the event that the value representative of the current status of the operating parameter exceeds the corresponding threshold (e.g., falls above a maximum threshold or falls below a minimum threshold), at block 410 the feedback controller 132 configures the adjustment signal ADJ so as to direct the voltage source 112 to adjust the output voltage V_{OUT} accordingly. To illustrate, if the minimum tail voltage is determined to fall below the tail voltage threshold range, the feedback controller 132 would direct the voltage source 112 to increase the output voltage V_{OUT} so as to raise the minimum tail voltage. Conversely, if the minimum tail voltage is determined to fall above the tail voltage threshold range, the feedback controller 132 would direct the voltage source 112 to decrease the output voltage V_{OUT} so as to decrease the minimum tail voltage.

FIG. 5 illustrates a chart 500 describing an example operation of the frame-based dynamic power management process implemented by the LED system 100 in accordance with at least one embodiment of the present disclosure. The chart 500 includes a line 501 representative of an example of the update reference 140 (FIG. 1), a line 502 representative of the frame-based power management process, and a line 503 representative of the magnitude of the output voltage V_{OUT}. For the example of FIG. 5, it is assumed that the update reference 140 has a frequency equal to the frame rate of the video data 136 (FIG. 1) such that the update reference 140 includes update triggers (e.g., pulses) synchronized to the start of the display of each image frame. It is also assumed for ease of illustration that any adjustment to the output voltage V_{OUT} in response to one update trigger is deemed to be sufficiently settled by the next update trigger.

At time t₁, an image frame is output for display and thus the update reference 140 is configured to include a pulse 504 as an update trigger. In response to the pulse 504 and in response to determining the output voltage V_{OUT} is sufficiently settled, the feedback controller 132 initiates an update process 506 for the output voltage V_{OUT} by determining the status of one or more operating parameters and adjusting the output voltage V_{OUT} accordingly. In the example of FIG. 5, this adjustment results in a decrease in the magnitude of the output voltage from a voltage V₁ to a voltage V₂ at time t₂, whereby the output voltage V_{OUT} is maintained at this magnitude until the start of the display of the next image frame. At time t₃, the next image frame is output for display and thus the update reference 140 is configured to include a pulse 508 as an update trigger. In response to the pulse 508 and in response to determining that the output voltage V_{OUT} is sufficiently settled at the voltage V₂, the feedback controller 132 initiates an update process 510 for the output voltage V_{OUT} by again determining the status of one or more operating parameters and adjusting the output voltage V_{OUT} accordingly. In the example of FIG. 5, this second adjustment results in an increase in the magnitude of the output voltage from the voltage V₂ to a voltage V₃ at time t₄, whereby the output voltage V_{OUT} is maintained at this magnitude until the start of the display of the next image frame.

As illustrated by FIG. 5, the LED driver 104 adjusts the output voltage V_{OUT} based at least partially on the frame rate of the video data 136 rather than continuously adjusting the output voltage V_{OUT}. By synchronizing the update process to the frame rate, the adjustment to the output voltage can be determined, implemented, and allowed to settle for a sufficient time before the next adjustment is initiated. Further, because the displayed image, and thus the activated LED strings, remains constant for the duration of the display of the image frame, the characteristics of the LED system are unlikely to vary significantly during any frame-synchronized update period, and therefore the characteristics of the LED system is unlikely to substantially change between the frame-based updates. Moreover, as discussed above, the feedback controller 132 may disregard one or more adjustment triggers if the previous adjustment to the output voltage V_{OUT} is deemed to be insufficiently settled, and thereby avoiding making further adjustments to the output voltage V_{OUT} based on operational parameters that may not accurately reflect the state of the LED system 100. Thus, the frame-based update process as described herein can reduce or eliminate the instability that often is a result of the continual adjustments to the output voltage as conducted by conventional LED systems.

FIGS. 6-11 illustrate a particular implementation of the frame-based dynamic power management process using minimum tail voltages as the operating parameter for adjusting the output voltage V_{OUT}. FIG. 6 illustrates a LED system 600 (corresponding to the LED system 100) that includes a LED panel 602, a LED driver 604, and a voltage source 612 for providing an output voltage V_{OUT} to drive the LED panel 602. The LED panel 602 includes a plurality of LED strings (e.g., LED strings 605, 606, and 607). Each LED string includes one or more LEDs 608 connected in series and each LED string is driven by the adjustable voltage V_{OUT} received at the head end of the LED string via a voltage bus 610 (e.g., a conductive trace, wire, etc.).

The LED driver 604 includes a data/timing controller 628 (corresponding to the data/timing controller 138, FIG. 1), an update controller 630 (corresponding to the update controller 130, FIG. 1), and a feedback controller 632 (corresponding to the feedback controller 132, FIG. 1) configured to control the voltage source 612 based on the tail voltages at the tail ends of the LED strings 605-607. As described in greater detail below, the LED driver 604, in one embodiment, receives pulse width modulation (PWM) data representative of which of the LED strings 605-607 are to be activated and at what times during a corresponding PWM cycle, and the LED driver 604 is configured to individually activate the LED strings 605-607 at the appropriate times in their respective PWM cycles based on the PWM data 634.

The feedback controller 632, in one embodiment, includes a code generation module 618, a code processing module 620, a control digital-to-analog converter (DAC) 622, and an error amplifier (or comparator) 624, and receives tail voltage inputs from a set of current regulators (e.g., current regulators 615, 616, and 617). In the example of FIG. 6, the current regulator 615 is configured to maintain the current I₁ flowing through the LED string 605 at or near a target current (e.g., 30 mA) when active. Likewise, the current regulators 616 and 617 are configured to maintain the current I₂ flowing through the LED string 606 when active and the current Iₙ flowing through the LED string 607 when active, respectively, at or near the target current. The current control modules 625, 626, and 627 are configured to activate or deactivate the LED strings 605, 606, and 607, respectively, via the corresponding current regulators.

The data/timing controller 628 receives the PWM data 634 and is configured to provide control signals to the other components of the LED driver 604 based on the timing and activation information represented by the PWM data 634. To illustrate, the data/timing controller 628 provides control signals C₁, C₂, and Cₙ to the current control modules 625, 626, and 627, respectively, to control which of the LED strings 605-607 are active during corresponding portions of their respective PWM cycles. The data/timing controller 628 also provides control signals to the code generation module 618, the code processing module 620, and the control DAC 622 so as to control the operation and timing of these components. Further, as described above, the data/timing controller 628 receives the video data 636 and generates a frame timing reference 638 (corresponding to the frame timing reference 138, FIG. 1) based on the frame rate information included in the video data 636. The data/timing controller 628 can be implemented as hardware, software executed by one or more processors, or a combination thereof To illustrate, the data/timing controller 628 can be implemented as a logic-based hardware state machine.

The update controller 630 is configured to generate an update reference 640 (corresponding to the update reference 140, FIG. 1) based on the frame rate and timing information represented by the frame timing reference 638 as described above. Alternately, as also described above, the update controller 630 can be configured to generate a virtual frame timing reference approximating or otherwise representing the expected frame rate (or expected maximum frame rate) of the video data 636 and use this virtual frame timing reference to generate the update reference as a harmonic or subharmonic of the virtual frame rate, or the virtual frame timing reference can be provided directly as the update reference 640. The update controller 630 provides the update reference 640 to one or more of the code generation module 618, the code processing module 620, and the control DAC 622 so as to control the timing and initiation of the periodic voltage update process performed by these components.

The code generation module 618 includes a plurality of tail inputs coupled to the tail ends of the LED strings 605-607 to receive the tail voltages V_{T1}, V_{T2}, and V_{Tn} of the LED strings 605, 606, and 607, respectively, and an output to provide a code value Cₘᵢₙ_{_{—}}min. In at least one embodiment, the code generation module 618 is configured to identify or detect the minimum, or lowest, tail voltage of the LED strings 605-607 that occurs over a PWM cycle, image frame display period, or other specified update period and generate the digital code value Cₘᵢₙ_{_{—}}min based on the identified minimum tail voltage. In the disclosure provided herein, the following nomenclature is used: the minimum of a particular measured characteristic over an update period or other specified duration is identified with the subscript “min₁₃ min”, thereby indicating it is the minimum over a specified time span; whereas the minimum of a particular measured characteristic at a given point in time or sample point is denoted with the subscript “min.” To illustrate, the minimum tail voltage of the LED strings 605-607 at any given point in time or sample point is identified as V_{Tmin}, whereas the minimum tail voltage of the LED strings 605-607 for a given update period (having one or more sample points) is identified as V_{Tmin}_{_{—}}min. Similarly, the minimum code value determined at a given point in time or sample point is identified as Cₘᵢₙ, whereas the minimum code value for a given update period (having one or more sample points) is identified as Cₘᵢₙ_{_{—}}min.

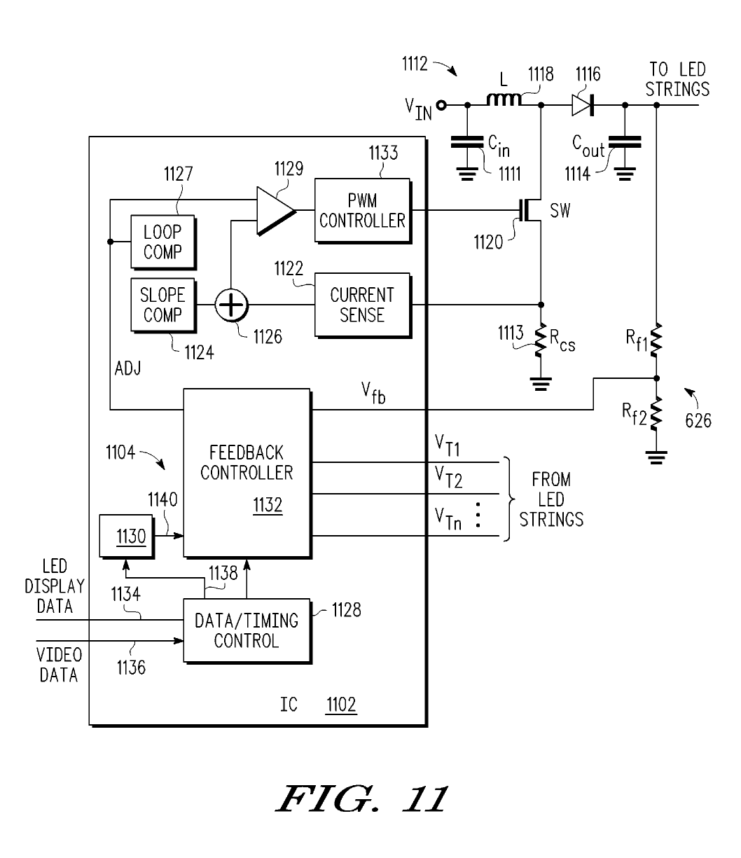

The code generation module 618 can include one or more of a string select module 631, a minimum detect module 633, and an analog-to-digital converter (ADC) 635. As described in greater detail below with reference to FIGS. 9 and 10, the string select module 631 is configured to output the minimum tail voltage V_{Tmin} of the LED strings 605-607 (which can vary over the update period), the ADC 635 is configured to convert the magnitude of the minimum tail voltage V_{Tmin} output by the string select module 631 to a corresponding code value Cₘᵢₙ for each of a sequence of conversion points in the update period, the minimum detect module 633 is configured as a digital component to detect the minimum code value Cₘᵢₙ from the plurality of code values Cₘᵢₙ generated over the update period as the minimum code value Cₘᵢₙ_{_{—}}min for the update period.

The code processing module 620 includes an input to receive the code value Cₘᵢₙ_{_{—}}min and an output to provide a code value C_{reg} based on the code value Cₘᵢₙ_{_{—}}min and either a previous value for C_{reg} from a previous update period or an initialization value. As the code value Cₘᵢₙ_{_{—}}min represents the minimum tail voltage V_{Tmin}_{_{—}}min that occurred during the update period for all of the LED strings 605-607, the code processing module 620, in one embodiment, compares the code value Cₘᵢₙ_{_{—}}min to a threshold code value, Cₜₕᵣₑₛₕ, and generates a code value C_{reg} based on the comparison. The code processing module 620 can be implemented as hardware, software executed by one or more processors, or a combination thereof. To illustrate, the code processing module 620 can be implemented as a logic-based hardware state machine, software executed by a processor, and the like. An example implementation of the code generation module 618 and the code processing module 620 is described in greater detail with reference to FIGS. 9 and 10.

In certain instances, none of the LED strings 605-607 may be enabled for a given update period. Thus, to prevent an erroneous adjustment of the output voltage V_{OUT} when all LED strings are disabled, in one embodiment the data/timing controller 628 signals the code processing module 620 to suppress any updated code value C_{reg} determined during a update period in which all LED strings are disabled, and instead use the code value C_{reg} from the previous update period.

The control DAC 622 includes an input to receive the code value C_{reg} and an output to provide a regulation voltage V_{reg} representative of the code value C_{reg}. The regulation voltage V_{reg} is provided to the error amplifier 624. The error amplifier 624 also receives a feedback voltage V_{fb} representative of the output voltage V_{OUT}. In the illustrated embodiment, a voltage divider 626 implemented by resistors 627 and 629 is used to generate the voltage V_{fb} from the output voltage V_{OUT}. The error amplifier 624 compares the voltage V_{fb} and the voltage V_{reg} and configures a signal ADJ based on this comparison. The voltage source 612 receives the signal ADJ and adjusts the output voltage V_{OUT} based on the magnitude of the signal ADJ.

There may be considerable variation between the voltage drops across each of the LED strings 605-607 due to static variations in forward-voltage biases of the LEDs 608 of each LED string and dynamic variations due to the on/off cycling of the LEDs 608. Thus, there may be significant variance in the bias voltages needed to properly operate the LED strings 605-607. However, rather than drive a fixed output voltage V_{OUT} that is substantially higher than what is needed for the smallest voltage drop as this is handled in conventional LED drivers, the LED driver 604 illustrated in FIG. 6 utilizes a feedback mechanism that permits the output voltage V_{OUT} to be adjusted so as to reduce or minimize the power consumption of the LED driver 604 in the presence of variances in voltage drop across the LED strings 605-607, as described below with reference to the methods 700 and 800 of FIG. 7 and FIG. 8, respectively. In at least one embodiment, this feedback mechanism is triggered by the update reference 640 so as to synchronize the updating of the output voltage with the frame rate of the video data 636.

FIG. 7 illustrates an example method 700 of operation of the LED system 600 in accordance with at least one embodiment of the present disclosure. At block 702, the voltage source 612 provides an initial output voltage V_{OUT}. As the PWM data 634 is received, the data/timing controller 628 configures the control signals C₁, C₂, and Cₙ so as to selectively activate the LED strings 605-607 at the appropriate times of their respective PWM cycles. Over the course of an update period, the code generation module 618 determines the minimum detected tail voltage (V_{Tmin}_{_{—}}min) for the LED tails 605-607 at block 704.

At block 706, the feedback controller 632 determines whether to update the output voltage V_{OUT}. In one embodiment, the feedback controller 632 can perform the update process every time the update reference 640 is asserted. Alternately, as described above, it may be appropriate to ensure that the last adjustment to the output voltage V_{OUT} has sufficiently settled, and thus the feedback controller 632 may disregard one or more assertions of the update reference 640 until a sufficient settling period has passed before initiating the next adjustment to the output voltage V_{OUT}. If no adjustment is to be made, the feedback controller 632 continues to monitor the tail voltages at block 704. Otherwise, at block 708 the feedback controller 632 configures the signal ADJ based on the voltage V_{Tmin min} to adjust the output voltage V_{OUT}, which in turn adjusts the tail voltages of the LED strings 605-607 so that the minimum tail voltage V_{Tmin} of the LED strings 605-607 is closer to a predetermined threshold voltage. The process of blocks 702-706 can be repeated for the next cycle of the update reference 140, and so forth.

As a non-zero tail voltage for a LED string indicates that more power is being used to drive the LED string than is absolutely necessary, it typically is advantageous for power consumption purposes for the feedback controller 632 to manipulate the voltage source 612 to adjust the output voltage V_{OUT} until the minimum tail voltage V_{Tmin}_{_{—}}min would be approximately zero, thereby eliminating nearly all excess power consumption that can be eliminated without disturbing the proper operation of the LED strings. Accordingly, in one embodiment, the feedback controller 632 configures the signal ADJ so as to reduce the output voltage V_{OUT} by an amount expected to cause the minimum tail voltage V_{Tmin}_{_{—}}min of the LED strings 605-607 to be at or near zero volts.

However, while being advantageous from a power consumption standpoint, having a near-zero tail voltage on a LED string introduces potential problems. As one issue, the current regulators 615-117 may need non-zero tail voltages to operate properly. Further, it will be appreciated that a near-zero tail voltage provides little or no margin for spurious increases in the bias voltage needed to drive the LED string resulting from self-heating or other dynamic influences on the LEDs 608 of the LED strings 605-607. Accordingly, in at least one embodiment, the feedback controller 632 can achieve a suitable compromise between reduction of power consumption and the response time of the LED driver 604 by adjusting the output voltage V_{OUT} so that the expected minimum tail voltage of the LED strings 605-607 is maintained at or near a non-zero threshold voltage Vₜₕᵣₑₛₕ that represents an acceptable compromise between PWM response time and reduced power consumption. The threshold voltage Vₜₕᵣₑₛₕ can be implemented as, for example, a voltage between 0.2 V and 1 V (e.g., 0.5 V).

FIG. 8 illustrates a particular implementation of the process represented by block 708 of the method 700 of FIG. 7 in accordance with at least one embodiment of the present disclosure. As described above, at block 706 (FIG. 7) of the method 700, the code generation module 618 monitors the tail voltages V_{T1}, V_{T2}, and V_{Tn} of the LED tails 605-607 to identify the minimum detected tail voltage V_{Tmin}_{_{—}}min in for a period measured by the update reference 640. In response to an assertion of the update reference 640 marking the end of this period, at block 802 the code generation module 618 converts the voltage V_{Tmin}_{_{—}}min to a corresponding digital code value Cₘᵢₙ_{_{—}}min. Thus, the code value Cₘᵢₙ_{_{—}}min is a digital value representing the minimum tail voltage V_{Tmin}_{_{—}}min detected during the preceding period. As described in greater detail herein, the detection of the minimum tail voltage V_{Tmin}_{_{—}}min can be determined in the analog domain and then converted to a digital value, or the detection of the minimum tail voltage V_{Tmin}_{_{—}}min can be determined in the digital domain based on the identification of the minimum code value Cₘᵢₙ_{_{—}}min from a plurality of code values Cₘᵢₙ representing the minimum tail voltage V_{Tmin} at various points over the period.

At block 804, the code processing module 620 compares the code value Cₘᵢₙ_{_{—}}min with a code value Cₜₕᵣₑₛₕ to determine the relationship of the minimum tail voltage V_{Tmin}_{_{—}}min (represented by the code value Cₘᵢₙ_{_{—}}min) to the threshold voltage Vₜₕᵣₑₛₕ (represented by the code value Cₜₕᵣₑₛₕ). As described above, the feedback controller 632 is configured to control the voltage source 612 so as to maintain the minimum tail voltage of the LED strings 605-607 at or near a threshold voltage Vₜₕᵣₑₛₕ during the corresponding period marked by the update reference 640. The voltage Vₜₕᵣₑₛₕ can be at or near zero volts to maximize the reduction in power consumption or it can be a non-zero voltage (e.g., 0.5 V) so as to comply with current regulation requirements while still reducing power consumption.

The code processing module 620 generates a code value C_{reg} based on the relationship of the minimum tail voltage V_{Tmin}_{_{—}}min to the threshold voltage Vₜₕᵣₑₛₕ revealed by the comparison of the code value Cₘᵢₙ_{_{—}}min to the code value Cₜₕᵣₑₛₕ. As described herein, the value of the code value C_{reg} affects the resulting change in the output voltage V_{OUT}. Thus, when the code value Cₘᵢₙ_{_{—}}min is greater than the code value Cₜₕᵣₑₛₕ, a value for C_{reg} is generated so as to reduce the output voltage V_{OUT}, which in turn is expected to reduce the minimum tail voltage V_{Tmin}_{_{—}}min closer to the threshold voltage Vₜₕᵣₑₛₕ. To illustrate, the code processing module 620 compares the code value Cₘᵢₙ_{_{—}}min to the code value Cₜₕᵣₑₛₕ. If the code value C_{min min} is less than the code value Cₜₕᵣₑₛₕ, an updated value for C_{reg} is generated so as to increase the output voltage V_{OUT}, which in turn is expected to increase the minimum tail voltage V_{Tmin}_{_{—}}min closer to the threshold voltage Vₜₕᵣₑₛₕ. Conversely, if the code value Cₘᵢₙ_{_{—}}min is greater than the code value Cₜₕᵣₑₛₕ, an updated value for C_{reg} is generated so as to decrease the output voltage V_{OUT}, which in turn is expected to decrease the minimum tail voltage V_{Tmin}_{_{—}}min closer to the threshold voltage Vₜₕᵣₑₛₕ. To illustrate, the updated value for C_{reg} can be set to

$$\begin{matrix}{C}_{reg} ( updated ) = {C}_{reg} ( current ) + offset 1 & EQ . 1 \\ offset 1 = \frac{{R}_{f 2}}{{R}_{f 1} + {R}_{f 2}} \times \frac{( {C}_{thesh} - {C}_{min\_min} )}{Gain\_ADC \times Gain\_DAC} & EQ . 2\end{matrix}$$

whereby R_{f1} and R_{f2} represent the resistances of the resistor 627 and the resistor 629, respectively, of the voltage divider 626 and Gain_{_{—}}ADC represents the gain of the ADC (in units code per volt) and Gain_{_{—}}DAC represents the gain of the control DAC 622 (in unit of volts per code). Depending on the relationship between the voltage V_{Tmin}_{_{—}}min and the voltage Vₜₕᵣₑₛₕ (or the code value Cₘᵢₙ_{_{—}}min and the code value Cₜₕᵣₑₛₕ), the offset1 value can be either positive or negative.

Alternately, when the code Cₘᵢₙ_{_{—}}min indicates that the minimum tail voltage V_{Tmin}_{_{—}}min is at or near zero volts (e.g., Cₘᵢₙ_{_{—}}min=0) the value for updated C_{reg} can be set to

C_{reg}(updated)=C_{reg}(current)+offset2 EQ. 3

whereby offset2 corresponds to a predetermined voltage increase in the output voltage V_{OUT} (e.g., 1 V increase) so as to affect a greater increase in the minimum tail voltage V_{Tmin}_{_{—}}min.

At block 806, the control DAC 622 converts the updated code value C_{reg} to its corresponding updated regulation voltage V_{reg}. At block 808, the feedback voltage V_{fb} is obtained from the voltage divider 626. At block 810, error amplifier 624 compares the voltage V_{reg} and the voltage V_{fb} and configures the signal ADJ so as to direct the voltage source 612 to increase or decrease the output voltage V_{OUT} depending on the result of the comparison as described above. The process of blocks 802-810 can be repeated for the next period marked by the update reference 640, and so forth.

FIG. 9 illustrates a particular implementation of the code generation module 618 and the code processing module 620 of the LED driver 604 of FIG. 6 in accordance with at least one embodiment of the present disclosure. In the illustrated embodiment, the code generation module 618 includes an analog string select module 902 (corresponding to the string select module 631, FIG. 6), an analog-to-digital converter (ADC) 904 (corresponding to the ADC 635, FIG. 6), and a digital minimum detect module 906 (corresponding to the minimum detect module 633, FIG. 6). The analog string select module 902 includes a plurality of inputs coupled to the tail ends of the LED strings 605-607 (FIG. 6) so as to receive the tail voltages V_{T1}, V_{T2}, and V_{Tn}. In one embodiment, the analog string select module 902 is configured to provide the voltage V_{Tmin} that is equal to or representative of the lowest tail voltage of the active LED strings at the corresponding point in time of an update period marked by the update reference 640. That is, rather than supplying a single voltage value at the conclusion of the period, the voltage V_{Tmin} output by the analog string select module 902 varies throughout the update period as the minimum tail voltage of the LED strings changes at various points in time of the update period.

The analog string select module 902 can be implemented in any of a variety of manners. For example, the analog string select module 902 can be implemented as a plurality of semiconductor p-n junction diodes, each diode coupled in a reverse-polarity configuration between a corresponding tail voltage input and the output of the analog string select module 902 such that the output of the analog string select module 902 is always equal to the minimum tail voltage V_{Tmin} where the offset from voltage drop of the diodes (e.g., 0.5 V or 0.7 V) can be compensated for using any of a variety of techniques.

The ADC 904 has an input coupled to the output of the analog string select module 902, an input to receive a clock signal CLK1, and an output to provide a sequence of code values Cₘᵢₙ over the course of the update period based on the magnitude of the minimum tail voltage V_{Tmin} at respective points in time of the update period (as clocked by the clock signal CLK1). The number of code values Cₘᵢₙ generated over the course of the update period depends on the frequency of the clock signal CLK1.

The digital minimum detect module 906 includes an input to receive the sequence of code values Cₘᵢₙ generated over the course of the update period by the ADC 904 and an input to receive the update reference 640. As the code values Cₘᵢₙ are received, the digital minimum detect module 906 determines the minimum, or lowest, of these code values. To illustrate, the digital minimum detect module 906 can include, for example, a buffer, a comparator, and control logic configured to overwrite a code value Cₘᵢₙ stored in the buffer with an incoming code value Cₘᵢₙ if the incoming code value Cₘᵢₙ is less than the one in the buffer. In response to an assertion of the update reference 640, the digital minimum detect module 906 provides the minimum code value Cₘᵢₙ of the series of code values Cₘᵢₙ for the update period as the code value Cₘᵢₙ_{_{—}}min to the code processing module 620. In response to receiving the code value Cₘᵢₙ_{_{—}}min and in response to the assertion of the update reference 640, the code processing module 620 compares the code value Cₘᵢₙ_{_{—}}min to the predetermined code value Cₜₕᵣₑₛₕ and generates an updated code value C_{reg} based on the comparison as described in greater detail above with reference to block 804 of FIG. 8.

FIG. 10 illustrates an example method 1000 of operation of the implementation of the LED system 600 illustrated in FIGS. 6 and 9 in accordance with at least one embodiment of the present disclosure. At block 1002, an update period starts, as indicated by an assertion of the update reference 640 (FIG. 6). At block 1004, the analog string select module 902 provides the minimum tail voltage of the LED strings at a point in time of the update period as the voltage V_{Tmin} for that point in time. At block 1006, the ADC 904 converts the voltage V_{Tmin} to a corresponding code value Cₘᵢₙ and provides it to the digital minimum detect module 906 for consideration as the minimum code value Cₘᵢₙ_{_{—}}min for the update period thus far at block 1008. At block 1010, the update controller 630 determines whether a new update period has started, i.e., whether the update reference 640 has been asserted a second time, thereby marking an end of the previous update period and the start of the next one. The code processing unit 620 as part of the feedback controller 132 determines whether there is a need to do an update based on the condition of other operating parameters of the LED drivers and whether sufficient settling period has occurred since the last adjustment to the output voltage V_{OUT}, if appropriate. If no need to update, the process of blocks 1004-1008 is repeated to generate another code value Cₘᵢₙ. Otherwise, an update is initiated and the minimum code value Cₘᵢₙ of the plurality of code values Cₘᵢₙ generated during the previous update period is provided as the code value C_{min min} by the digital minimum detect module 906. In an alternate embodiment, the plurality of code values Cₘᵢₙ generated during the previous update period are buffered and then the minimum value Cₘᵢₙ_{_{—}}min is determined at the end of the previous update period from the plurality of buffered code values Cₘᵢₙ. At block 1012 the code processing module 620 uses the minimum code value Cₘᵢₙ_{_{—}}min to generate an updated code value C_{reg} based on a comparison of the code value Cₘᵢₙ_{_{—}}min to the predetermined code value Cₜₕᵣₑₛₕ. The control DAC 622 uses the updated code value C_{reg} to generate the corresponding voltage V_{reg}, which is used by the error amplifier 624 along with the voltage V_{fb} to adjust the output voltage V_{OUT} for the current update period as described above.

FIG. 11 illustrates an IC-based implementation of the LED system 100 of FIG. 1 or the LED system 600 of FIG. 6 as well as an example implementation of a voltage source 1112 in accordance with at least one embodiment of the present disclosure. In the depicted example, an LED driver 1104 (corresponding to either the LED driver 104 of FIG. 1 or the LED driver 604 of FIG. 6) is implemented as an integrated circuit (IC) 1102 having a data/timing controller 1128, an update controller 1130 and a feedback controller 1132, that operate on video data 1136 (corresponding to video data 136, FIG. 1) and LED display data 1134 (corresponding to LED display data 134, FIG. 1) to generate a frame timing reference 1138 (corresponding to frame timing reference 138, FIG. 1) and an update reference 1140 (corresponding to update reference 140, FIG. 1), as described above. As also illustrated, some or all of the components of the voltage source 1112 can be implemented at the IC 1202. In one embodiment, the voltage source 1112 can be implemented as a step-up boost converter, a buck-boost converter, and the like. To illustrate, the voltage source 1112 can be implemented with an input capacitor 1111, a resistor 1113, an output capacitor 1114, a diode 1116, an inductor 1118, a switch 1120, a current sense block 1122, a slope compensator 1124, an adder 1126, a loop compensator 1127, a comparator 1129, and a PWM controller 1133 connected and configured as illustrated in FIG. 11.

The term “another”, as used herein, is defined as at least a second or more. The term “subset,” as used herein, is defined as one or more of a larger set, inclusive. The terms “including”, “having”, or any variation thereof, as used herein, are defined as comprising. The term “coupled”, as used herein with reference to electro-optical technology, is defined as connected, although not necessarily directly, and not necessarily mechanically.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
providing an output voltage to a head end of at least one light emitting diode (LED) string;
providing a frame timing reference based on a frame rate of a series of image frames to be displayed; and
adjusting the output voltage responsive to the frame timing reference.

2. The method of claim 1, wherein adjusting the output voltage responsive to the frame timing reference comprises:
in response to an adjustment trigger associated with the frame timing reference:
initiating an adjustment to the output voltage responsive to determining a previous adjustment to the output voltage has sufficiently settled; and
avoiding initiation of an adjustment to the output voltage responsive to determining the previous adjustment to the output voltage has not sufficiently settled.

3. The method of claim 2, further comprising:
adjusting the output voltage responsive to the frame timing reference further comprises adjusting the output voltage responsive to a value of an operating parameter associated with the at least one LED string; and
the method further comprising determining whether the previous adjustment to the output voltage has sufficiently settled based on a duration over which the value of the operating parameter is determined.

4. The method of claim 1, wherein adjusting the output voltage responsive to the frame timing reference comprises adjusting the output voltage responsive to an update reference having a frequency that is one of a harmonic of the frame rate or a subharmonic of the frame rate.

5. The method of claim 1, providing the frame timing reference comprises generating the frame timing reference as a virtual frame timing reference representative of the frame rate of the video data.

6. The method of claim 5, further comprising:
dynamically adjusting the virtual frame timing reference responsive to expected changes in the frame rate of the video date.

7. The method of claim 1, wherein adjusting the output voltage responsive to the frame timing reference comprises:
determining, at a first time identified based on the frame timing reference, a first relationship between a first value of an operating parameter of the at least one LED string and a predetermined threshold associated with the operating parameter; and
adjusting, at a second time subsequent to the first time, the output voltage based on the first relationship.

8. The method of claim 7, further comprising:
determining, at a third time identified based on the frame timing reference, a second relationship between a second value of the operating parameter and the predetermined threshold, the third time subsequent to the second time; and
adjusting, at a fourth time subsequent to the third time, the output voltage based on the second relationship.

9. The method of claim 7, wherein:
the at least one LED string comprises a plurality of LED strings;
each LED string of the plurality of LED strings has a corresponding tail voltage responsive to the output voltage;
the operating parameter comprises a minimum tail voltage of the tail voltages of the plurality of LED strings; and
the predetermined threshold comprises a target voltage for the minimum tail voltage.

10. The method of claim 7, wherein:
the operating parameter comprises a magnitude of the output voltage; and
the predetermined threshold comprises a target magnitude for the output voltage.

11. A method comprising:
providing an output voltage to a head end of each of a plurality of light emitting diode (LED) strings, each LED string having a corresponding tail voltage responsive to the output voltage;
providing a frame timing reference based on a frame rate of a series of image frames to be displayed; and
responsive to the frame timing reference:
determining a minimum tail voltage of the plurality of LED strings; and
adjusting the output voltage based on the minimum tail voltage.

12. The method of claim 11, wherein adjusting output voltage based on the minimum tail voltage comprises:
increasing the output voltage in response to determining the minimum tail voltage is less than a predetermined threshold voltage; and
decreasing the output voltage in response to determining the minimum tail voltage is greater than the predetermined threshold voltage.

13. The method of claim 11, wherein:
determining the minimum tail voltage of the plurality of LED strings comprises determining a minimum tail voltage of the plurality of LED strings for a duration of a display of a first image frame of the series of images frames; and
adjusting the output voltage based on the minimum tail voltage comprises adjusting the output voltage based on the minimum tail voltage in response to a start of a display of a second image frame, the second image frame following the first image frame in the series of image frames.

14. The method of claim 11, wherein adjusting the output voltage based on the minimum tail voltage comprises:
generating a first code value based on the minimum tail voltage;
generating a second code value based on a comparison of the first code value to a third code value, the third code value representing a predetermined threshold voltage for tail voltages of the plurality of LED strings;
generating a first voltage based on the second code value;
determining a second voltage representative of the output voltage; and
adjusting the output voltage based on a relationship between the first voltage and the second voltage.

15. The method of claim 11, wherein providing the frame timing reference comprises generating the frame timing reference as a virtual frame timing reference representative of the frame rate of the video data.

16. A system comprising:
a voltage source configured to provide an adjustable output voltage to a head end of at least one light emitting diode (LED) string; and
a LED driver configured to:
determine a frame timing reference based on a frame rate of a series of image frames to be displayed; and
adjust the output voltage of the voltage source responsive to the frame timing reference.

17. The system of claim 16, wherein the LED driver further is configured to:
generate an update reference based on the frame timing reference and a previous update status of the output voltage; and
wherein the LED driver is configured to adjust the output voltage of the voltage source responsive to the update reference.

18. The system of claim 16, wherein the LED driver is configured to determine the frame timing reference comprises generating a virtual frame timing reference representative of the frame rate of the video data.

19. The system of claim 18, wherein the LED driver further is configured to:
dynamically adjust the virtual frame timing reference responsive to expected changes in the frame rate of the video date.

20. The system of claim 16, wherein the LED driver further is configured to:
determine, at a first time determined based on the frame timing reference, a first relationship between a first value of an operating parameter of the at least one LED string and a predetermined threshold;
determine, at a second time determined based on the frame timing reference, a second relationship between a second value of the operating parameter and the predetermined threshold, the third time subsequent to the first time; and
wherein the LED driver is configured to adjust the output voltage by:
adjusting, at a third time, the output voltage based on the first relationship, the third time subsequent to the first time and prior to the second time; and
adjusting, at a fourth time, the output voltage based on the second relationship, the fourth time subsequent to the second time.

21. The system of claim 20, wherein:
the at least one LED string comprises a plurality of LED strings;
each LED string of the plurality of LED strings has a corresponding tail voltage responsive to the output voltage;
the operating parameter comprises a minimum tail voltage of the tail voltages of the plurality of LED strings; and
the predetermined threshold comprises a target voltage for the minimum tail voltage.

22. The system of claim 20, wherein:
the operating parameter comprises a magnitude of the output voltage; and
the predetermined threshold comprises a target magnitude for the output voltage.
